(19) United States
(12) Patent Application Publication
(10) Pub. No.: US 2017/0315567 A1
(43) Pub. Date: Nov. 2, 2017

(54) FLOW REGULATION DEVICE HAVING A DEFORMABLE TUBULAR MEMBRANE, FLUID DISTRIBUTION LINE AND APPARATUS COMPRISING SUCH A DEVICE

(71) Applicant: Serac group, LA FERTE BERNARD (FR)

(72) Inventor: André Jean Jacques GRAFFIN, Chicago, IL (US)

(21) Appl. No.: 15/523,310

(22) PCT Filed: Oct. 25, 2015
(86) PCT No.: PCT/EP2015/075182

§ 371 Date: Apr. 28, 2017

(30) Foreign Application Priority Data
Oct. 31, 2014 (FR) 1460519

(51) Int. Cl. G05D 7/06; B65B 3/26; B65B 3/12

(52) U.S. Cl. CPC G05D 7/0676; B65B 3/12; B65B 3/26

(57) ABSTRACT

Flow regulation device having a rigid external envelope surrounding an internal tube and defining, with same, an annular chamber. The device has ends which allow for sealed connection thereof to a fluid line to be regulated, such that the internal tube is connected in series to said line. The chamber has a device for introducing a pressurized regulation fluid therein, the internal tube being configured to dilate under the pressure of the fluid to be regulated when the pressure of the fluid to be regulated exceeds the pressure of the regulating fluid. The device has a detector of the dilation of the internal tube, and a connection device from the detector to a control unit of a source connected to the line. Fluid distribution line and apparatus having such a device.

### BACKGROUND OF THE INVENTION

### Field of the Invention

The present invention relates to regulating fluids in a circuit such as a fluid distribution circuit.

### Brief Discussion of the Related Art

By way of example, such a distribution circuit is used in filler installations for filling containers in order to feed liquid to a filler machine arranged to fill the containers with said liquid. The filler machine is connected to a tank for storing liquid by a distribution line on which a variable-flow pump is mounted. Since the machine needs to be fed with liquid at a pressure that is substantially constant, operation of the pump is generally servo-controlled as a function of the pressure detected downstream from the pump by a pressure sensor mounted on the line or on the filler machine: as soon as the pressure drops, the pump is controlled so as to accelerate. However, the pressure may vary quite considerably as a function of the rate of operation of the filler machine, in particular during transient stages, on starting and stopping the machine. Given the differences that exist between the dynamic range of the pressure sensor and the response time of the pump, the pressure of the liquid may fluctuate between values below and above the setpoint pressure, and fluid hammer phenomena may occur.

In order to overcome that drawback, it is known to connect a buffer accumulator in parallel with the line in order to absorb variations in pressure. However, that solution is not advantageous in particular in installations for filling liquids that are foodstuffs. Those installations need to be cleaned periodically and that cleaning is performed by passing a cleaning fluid in the circuit of the installation. Although the cleaning fluid flows correctly in the distribution line and cleans it effectively, it is difficult to cause the cleaning fluid to flow in the accumulator unless valves are provided for that purpose, and that complicates the circuit of the installation.

### SUMMARY OF THE INVENTION

An object of the invention is to provide means that make it possible to improve maintaining a substantially constant pressure in a product distribution line.

To this end, there is provided a fluid line for distributing a fluid at a predetermined pressure, the line comprising in series a variable-flow source and a flow regulator device comprising a rigid outer casing surrounding an inner tube and defining therewith an annular chamber, the device having ends provided with means for leaktight connection to the fluid line in such a manner that the inner tube is connected in series to the fluid line to be regulated, the chamber comprising means for introducing therein a regulation fluid under pressure, the inner tube being arranged to expand under the pressure of the fluid to be regulated when the pressure of the fluid to be regulated exceeds a threshold that depends on the pressure of the regulation fluid, and the device including an expansion detector for detecting expansion of the inner tube, the source and the expansion detector being connected to a control unit that is programmed to govern the source as a function of the signal provided by the expansion detector in such a manner as to keep the pressure of the fluid to be regulated at the predetermined pressure value.

For an elastically-deformable inner tube, it should be understood that the threshold depends on the pressure of the regulation fluid that is adjusted as a function of a setpoint pressure of the fluid to be regulated. When the pressure of the fluid to be regulated increases to the point of exceeding the threshold, the inner tube expands and the source is controlled as a function of the expansion of the inner tube in order to limit the increase in pressure downstream from the device and to return the pressure downstream from the device to the setpoint pressure.

The invention also provides a filler installation comprising a liquid tank connected via said distribution line to a filler machine for filling containers.

Other characteristics and advantages of the invention appear on reading the following description of particular, non-limiting embodiments of the invention.

### BRIEF DESCRIPTION OF THE DRAWINGS

Reference is made to the accompanying drawings, in which:

FIG. 1 is a diagrammatic view of a filler installation in accordance with the invention;

FIG. 2 is a perspective view in transparency of a regulator device in accordance with the invention;

FIG. 3 is a fragmentary view of the device in perspective and in longitudinal section; and

FIG. 4 is a detail view of FIG. 3.

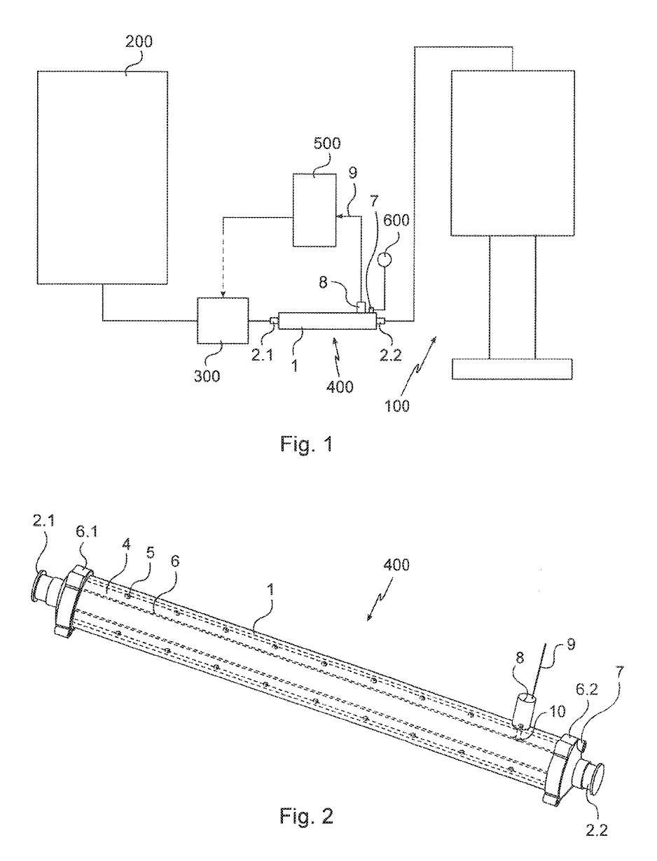

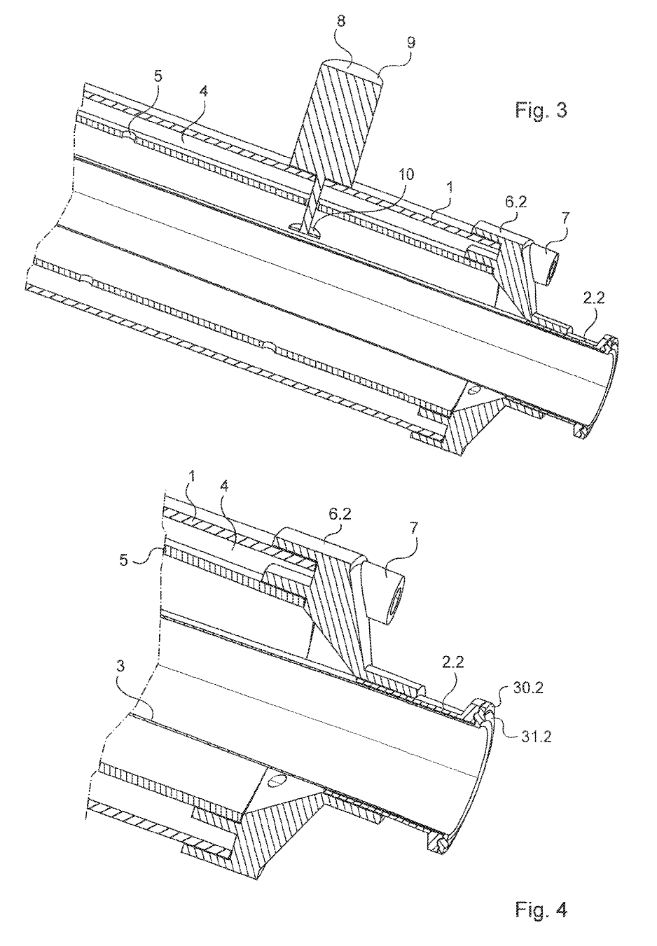

### DETAILED DESCRIPTION OF THE PREFERRED EMBODIMENTS

The invention is described with application to an installation for filling containers.

With reference to the figures, the filler installation comprises a filler machine 100 connected to a liquid tank 200 via a distribution line. The distribution line comprises in series a variable-flow pump 300 and a regulator device, given overall reference 400, downstream from the pump 300. The pump 300 and the regulator device are connected to a control unit 500 programmed to govern the pump 300 on the basis of a signal coming from the regulator device 400. The filler machine 100, the liquid tank 200, and the pump 300 are themselves known and are not described further.

The regulator device 400 comprises an outer casing 1, in this example a rigid casing of tubular shape, surrounding an inner tube 3 and an intermediate tube 5 disposed between the inner tube 3 and the outer casing 1, at a distance therefrom. The outer casing 1, the inner tube 3, and the intermediate tube 5 are coaxial. The inner tube 3 projects beyond both ends of the intermediate tube 5 and of the outer casing 1, which are both of the same length.

An upstream cover 6.1 and a downstream cover 6.2, both of annular shape, are mounted on the ends of the inner tube 3, of the intermediate tube 5, and of the outer casing 1.1. Each cover 6.1, 6.2 includes two circular housings in which the ends of the intermediate tube 5 and of the outer casing 1 are engaged and fastened in leaktight manner, and a central bore in which the end of the inner tube 3 is engaged and fastened in leaktight manner. It should be understood that the covers 6.1, 6.2 form spacers holding the inner tube 3, the intermediate tube 5, and the outer casing 1.1 in position relative to one another. An annular chamber 4 is thus formed between the inner tube 3 and it is subdivided into two compartments by the intermediate tube 5. The intermediate tube 4 is pierced with holes so as to put the two compartments into communication.

The inner tube 3 comprises a tubular elastomer wall having ends that are respectively engaged in and fastened to an upstream tubular endpiece 2.1 and a downstream tubular endpiece 2.2. Both of the tubular endpieces 2.1, 2.2 are rigid and they make it possible to fasten the elastomer wall to the covers 6.1, 6.2. Each end of the elastomer wall of the inner tube 3 includes a rim projecting laterally outwards (only the rim 30.2 of the downstream end is visible in FIG. 4) covering a face of a collar of the corresponding tubular endpiece (only the collar of the downstream tubular endpiece 2.2 is visible). An annular flange (only the annular flange 31.2 of the rim 30.2 of the downstream end is visible in FIG. 4) extends axially on either side of the rim in order to form a sealing gasket. The annular flange is obtained by being molded integrally with the rim. The tubular endpieces 2.1, 2.2, the rims (in particular 30.2), and the annular flanges (in particular 31.2) form leaktight connection means for connecting the regulator device 400 to the distribution line in such a manner that the inner tube 3 is connected in series to the distribution line. To this end, the distribution line has ends provided with lips that are pressed against the annular flanges in known manner e.g. by clamps, cuffs, or screw-and-nut assemblies.

The chamber 4 includes means for introducing therein a regulation fluid under pressure, in this example: air. The means for introducing regulation fluid under pressure comprise a pressure reducing regulator 7 connected to an air pressure source 600 and fastened to the cover 6.2 so as to lead into the chamber 4 between the intermediate tube 5 and the outer casing 1.

The regulator device 400 includes an expansion detector 8 for detecting expansion of the inner tube 3. The detector 8 is arranged to provide a signal that is proportional to the expansion of the inner tube 3, and it is provided with an electrical connection cable 9 for connection to the control unit 500 so as to provide said control unit with said proportional signal. The detector 8 is mounted between the intermediate tube 5 and the outer casing 1 and has a feeler 10 extending between the intermediate tube 5 and the inner tube 3.

In operation, the pump 300 is governed by the control unit 500 so as to maintain the liquid for distribution at a predetermined setpoint pressure.

Air is introduced under pressure into the chamber 4 via the pressure reducing regulator 7. The air pressure is determined as a function of the setpoint pressure in order to define a threshold, which is used as explained below.

The liquid for distribution runs though the inner tube 3, which tube expands under the pressure of the liquid for distribution when the pressure of the liquid for distribution exceeds the threshold that depends on the pressure of the regulation fluid. The expanding inner tube 3 comes into contact with the feeler 10 and moves it. The detector 8 then provides the control unit 500 with a signal, and the control unit 500 uses the signal to govern the pump 3 in such a manner as to keep constant the pressure of the liquid for distribution in the line downstream from the pump 300.

In the embodiment described, the control unit interrupts the pump as soon as it receives the signal from the detector 8.

The inner tube 3 is thus arranged so as to be able to expand as from a pressure of the liquid for distributing that is at the lower limit of the range of pressures for the liquid for distributing that is usually used in such an installation. In this example, the elastomer wall of the inner tube 3 is made of a silicone elastomer and has a thickness of about 0.5 millimeters (mm). The inner tube can expand without deterioration, i.e. remaining within its elastic limits, until it reaches a maximum diameter, in this embodiment equal to about twice its diameter at rest. The intermediate tube 5 is positioned so as to limit expansion of the inner tube 3 to said maximum diameter.

The material and the dimensions of the inner tube 3 are selected in such a manner as to limit the resistance of the material to expansion so as to have the most direct link possible between the air pressure value in the chamber 4 and the pressure of the liquid for distribution. The air pressure in the chamber 4 may then be substantially equal to the setpoint pressure since resistance of the material to expansion can be ignored.

The volume of the chamber 4 is sufficient for absorbing rapid expansion of the inner tube 3 by limiting the relative variations of the volume of air contained in the chamber 4 (in the event of a chamber of small volume, a safety valve allowing excess pressure to be evacuated is preferably provided).

It should be observed that the device is easy to clean in a closed circuit.

Naturally, the invention is not limited to the embodiments described but encompasses any variant coming within the ambit of the invention as defined by the claims.

In particular, the device may have a structure different to that described. In particular, the device need not have an intermediate tube, the outer casing defining a single chamber. In order to preserve a sufficient volume of regulation fluid, it may be envisaged to connect said chamber to an external regulation fluid tank.

The definition of the invention should be interpreted as also covering inverting the components of the regulator device.

Other methods of connecting the regulator device to the line may be envisaged.

Other methods of detecting expansion may be envisaged. By way of example, in a variant, the detector comprises a proximity sensor mounted on the outer casing and facing a metal pellet fastened on the inner tube 3.

The detector may provide a signal that is proportional to the expansion of the inner tube 3.

It is possible to provide two thresholds for governing the pump so as to maintain expansion of the inner tube between these two thresholds.

The regulator device may be mounted on the line supplying the filler machine or on the line returning to the tank the fluid for distribution that has not been used by the filler machine.

The invention applies to any type of installation comprising a circuit of fluid to be regulated, whether it is in the field of packaging or elsewhere.

1. A fluid line for distributing a fluid at a predetermined pressure, the line comprising in series a variable-flow source and a flow regulator device comprising a rigid outer casing surrounding an inner tube and defining therewith an annular chamber, the device having ends provided with means for leaktight connection to the fluid line in such a manner that the inner tube is connected in series to the fluid line to be regulated, the chamber comprising means for introducing therein a regulation fluid under pressure, the inner tube being arranged to expand under the pressure of the fluid to be regulated when the pressure of the fluid to be regulated exceeds a threshold that depends on the pressure of the regulation fluid and the device including an expansion detector for detecting expansion of the inner tube, the source and the expansion detector being connected to a control unit that is programmed to govern the source as a function of the signal provided by the expansion detector in such a manner as to keep the pressure of the fluid to be regulated at the predetermined pressure value.

2. The fluid line according to claim 1, wherein a pierced intermediate tube extends coaxially inside the annular chamber in order to limit expansion of the inner tube.

3. The fluid line according to claim 2, wherein the expansion detector is mounted between the intermediate tube and the outer casing.

4. The fluid line according to claim 1, wherein the means for introducing regulation fluid under pressure comprise a pressure-reducing regulator.

5. The fluid line according to claim 1, wherein the detector comprises a proximity sensor mounted on the outer casing facing a metal pellet fastened on the inner tube.

6. The fluid line according to claim 1, wherein the inner tube comprises a tubular elastomer wall having ends fastened to rigid tubular endpieces engaged in ends of the outer casing.

7. The fluid line according to claim 6, wherein each end of the inner tube includes a rim projecting laterally outwards covering a face of a collar of the endpiece corresponding thereto, an annular flange projecting axially from the rim in order to form a sealing gasket.

8. A filler installation comprising a liquid tank connected to a filler machine for filling containers via a distribution line according to claim 1.
